(19) United States
(12) Patent Application Publication
(10) Pub. No.: US 2025/0315702 A1
(43) Pub. Date: Oct. 9, 2025

(54) REAL-WORLD IMPACT COMPREHENSION SYSTEM, ENGINE, AND INTERFACE

(71) Applicant: Professional Impact, Inc., Norwalk, CT (US)

(72) Inventor: Wendy Lipton-Dibner, Norwalk, CT (US)

(73) Assignee: Professional Impact, Inc., Norwalk, CT (US)

(21) Appl. No.: 19/170,030

(22) Filed: Apr. 3, 2025

Related U.S. Application Data
(60) Provisional application No. 63/574,032, filed on Apr. 3, 2024.

(51) Int. Cl. G06N 5/045

(52) U.S. Cl. CPC G06N 5/045

(57) ABSTRACT

A machine comprehension system, interface, and paradigm generator configured to generate machine-comprehendible real-world impact paradigms. There is a query prompt interface that automatically solicits and produces causally-linked natural-language real-world impact metrics from one or more entities, including a natural language text input system and a paradigm generator functionally coupled to the query prompt interface, wherein the paradigm generator assembles causally-linked natural-language real-world impact metrics received therefrom into a machine-readable causal model. The nodes of the causal model are organized/weighted by area, importance, time, and self/other-ness. There is an expression generator in functional communication with the machine-readable causal model such that it can generate natural-language expressions derived therefrom.

### CROSS-REFERENCE TO RELATED APPLICATIONS

This invention claims priority, under 35 U.S.C. § 120, to the U.S. Provisional Patent Application No. 63/574,032 to Wendy Lipton-Dibner filed on Apr. 2, 2024 which is incorporated by reference herein in its entirety.

### BACKGROUND OF THE INVENTION

### Field of the Invention

The present invention relates to computerized intelligence systems, specifically to computerized comprehension systems, engines, and interfaces.

### Description of the Related Art

In the 1950's there was an excited push in the United States to develop artificial intelligence (AI). By the 1970s it became clear that the task was far more difficult than they had imagined. Recently, there has been a huge boom in progress towards more useful AI with the public release of large language models (LLM). That progress has also created an intense dialog regarding the potential risks and ethical concerns that come with such a powerful tool. This is also evident in the abundance of modern fiction where AI “goes crazy” (e.g. 2001: A Space Odyssey; Dune, Portal (video game)). With any new tool that has been developed there are new safety concerns and the more powerful the tool the greater the concern.

Some of the efforts to improve artificial intelligence and reduce safety concerns include efforts to make the AI more human. LLM and natural language processing (NLP) technologies have allowed AI to sound more human and to better engage with natural language requests instead of requiring specialized user interfaces. Speech synthesis (e.g. text to speech), voice cloning, and deepfake audio have improved the ability for computerized systems to sound more human and to engage with people through voice. Conversational agents like Siri, Alexa, and Google Assistant engage with people using human-like dialog. Improvements have also been made in sentiment analysis and facial recognition (e.g. Synthesia, DeepFaceLab, Affectiva, EmoVu) to give AI an improved capacity to engage with human emotions. Further, affective computing (e.g. Replika, Kuki AI) has made strides forward in understanding and responding to human emotion and the human experience.

One of the major concerns relates to giving computerized systems more authority and responsibility is with an AI system moving forward very effectively with some activity without fully understanding the impact those actions would have on the associated humans. Further, this is a valid concern even when human agents are in control. Accordingly, understanding the human experience is something that is of interest to technologists. Some improvements have been made in the field. Examples of references related to the present invention are described below in their own words, and the supporting teachings of each reference are incorporated by reference herein:

U.S. Pat. No. 12,137,023 issued to Malleshaiah et. al. discloses systems and methods include monitoring user experience of one or more users accessing any of the Internet, cloud applications, and private applications; determining a user experience score for the one or more users; responsive to detecting a low user experience score for a user, performing one or more analyses on the user experience of the user; and determining a root cause of the low user experience score based on the one or more analyses. The systems and methods can include determining a remedial action for the user based on the root cause.

U.S. Pat. No. 11,915,174 issued to Moorthy et. al. discloses an apparatus, method, and computer program product are provided for the improved and automatic prediction and modeling of one or more channels and relevant conditions through which resources may be directed to users in an environment where resource demand, utility, and perceived value vary over time. Some example implementations employ predictive, machine-learning modeling to facilitate the use of multiple disparate and unrelated data sets to extrapolate and otherwise predict the future needs for certain resources and identify the channels and conditions that may be employed to meet such future needs. An apparatus, method, system, and computer program product are provided for improved generating, adjusting, and/or facilitating approval of a resource offer set. Some example implementations employ one or more predictive models.

U.S. Patent Application Publication No.: 20230281636A1, by Pfaff et. al., discloses systems and methods for generating customer experience scores. An example method may include determining, via a processor, a first event impacting one or more users on a network. The example method may also include determining, via the processor, a first time period during which the first event occurs. The example method may also include determining, via the processor, a first number of interactions that occurred during the first time period between the one or more users and a network service provider. The example method may also include determining, via the processor and using a correlation model, a first relationship between the first event and the first number of interactions during the first time period. The example method may also include determining, via the processor, a second event impacting a first user. The example method may also include determining, using the machine learning model and based on the second event, a first metric indicative of an experience of the first user, wherein the first event and second event are a same type of event.

U.S. Patent Application Publication No.: 20210201335A1, by Purohit et. al., discloses methods and systems for determining a customer experience score. The methods and systems are configured to receive customer interaction data indicative of customer interaction events with a service provider, receive weight configuration data indicative of a weight associated with the events in the customer interaction data, and calculate the customer experience score for each customer contained in the customer interaction data based on the events identified in the customer interaction data and the weight configuration data.

The inventions heretofore known suffer from a number of disadvantages which include being limited in scope to the understanding of the system/method developer, failing to understand causation of experience, failing to capture experience, being applicable only to limited contextual implementation, failing to produce useful composite information, failing to produce useful individual information, being limited in scope or volume, and failing to generate accountability.

What is needed is a system, generator, and/or interface that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems, model/paradigm generators, and interfaces. Accordingly, the present invention has been developed to provide a machine comprehension system that may be configured to generate machine-comprehendible real-world impact paradigms. The system may include one or more of a query prompt interface that may automatically solicits and/or produces causally-linked natural-language real-world impact metrics from one or more entities, including a natural language text input system; and/or a paradigm generator that may be functionally coupled to the query prompt interface. It may be that the paradigm generator assembles causally-linked natural-language real-world impact metrics received therefrom into a machine-readable causal model. There may also be an expression generator in functional communication with the machine-readable causal model such that it can generate expressions derived therefrom.

It may be that: the expression generator includes an expression script that generates natural-language expressions; the natural-language causally-linked real-world impact metrics solicited by the query prompt interface includes at least one importance index; the importance index includes at least one desirable desirability rating and at least one undesirable desirability rating; the importance index includes at least one self-only importance rating and at least one self-and-others importance rating; the causally-linked natural-language real-world impact metrics solicited by the query prompt interface is metadata-enriched according to a natural language impact area; the natural language text input system includes schema extender that extends the set of natural language impact areas according to natural language input from an entity solicited thereby; the machine-readable causal model includes a common initiating node associated with a root event to which all assembled causally-linked natural-language real-world impact metrics are causally connected; the wherein the machine-readable causal model is a directed acyclic graph (DAG) with weighted node importance for nodes associated with a single initiating node; and/or the system time-stamps causally-linked natural-language real-world impact metrics; the paradigm generator appends differential weighting metadata to an assembled causally-linked natural-language real-world impact metrics according to a time-stamp schema based on a time schedule centered on a time-stamp associated with a root event associated with an entity associated with the assembled causally-linked natural-language real-world impact metric.

According to another non-limiting embodiment, there may be a special-purpose paradigm generator that generates a machine-readable real-world causal model. Such may include one or more of: a real-world input port that may be configured to receive causally-linked natural-language real-world impact metrics that may be associated with a root event; a common initiating node that may be associated with the root event; and/or a schema composer that may functionally couple received causally-linked natural-language real-world impact metrics to the common initiating node which may be in accordance with causality information included with the received causally-linked natural-language real-world impact metrics thereby appending an impact node to a schema including the common initiating node.

It may be that: the impact nodes are metadata enriched with weighting; the impact nodes are metadata enriched with time information relative to time information of the root event; the weighting includes time differential weighting; the weighting includes importance weighting; the weighting includes both desirability and undesirability weighting; the impact nodes are metadata enriched with self or self-plus-other ratings; and/or the impact nodes are metadata enriched with natural-language impact area.

In still another non-limiting embodiment, there may be a special-purpose query prompt interface that may automatically generates machine-readable causally-linked natural-language real-world impact metrics. Such may include one or more of: a root event informational component that displays a natural-language expression of a root event; and/or an input control. The input control may include one or more of: a selection input system for receiving real-world impact node selection input and causality selection input from an entity; a natural language text input system for receiving natural-language input from an entity and thereby generating real-world impact nodes therefrom not already available for selection via the selection input system; a metric generator that generates causally-linked natural-language real-world impact metrics based on received impact node and causality selection by the entity by linking received real-world impact node selection input and causality selection input to the root event in a machine-readable form.

It may be that: the query prompt interface time stamps the real-world impact node selection input; the selection input system further receives selection input of an importance index associated with a selected real-world impact node selection input; the desirability index includes at least one desirable desirability rating and at least one undesirable importance rating; the importance index includes at least one self-only importance rating and at least one self-and-others importance rating; the selection input system further receives selection input of an area associated with a selected real-world impact node selection input; and/or the natural language text input system includes schema extender that extends the set of natural language impact areas according to natural language input from an entity solicited thereby.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a block diagram of a machine comprehension system, according to one embodiment of the invention;

FIG. 2 is a block diagram of a query prompt interface, according to one embodiment of the invention;

FIG. 3 is a block diagram of a paradigm engine, according to one embodiment of the invention; and

FIGS. 4-18 are prophetic screenshots of a web-based user interface of a query prompt interface showing deployment thereof from the point of view of a human entity providing real-world impact metrics, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

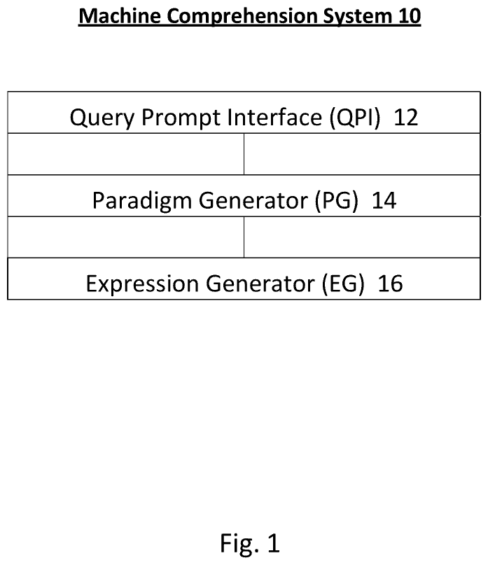

FIG. 1 is a block diagram of a machine comprehension system, according to one embodiment of the invention. There is shown a query prompt interface (QPI) functionally coupled to a paradigm generator (PG) that is functionally coupled to an expression generator (EG). Advantageously, the illustrated machine comprehension system collects real-world impact metrics and generates a machine-readable causal model that then is expressed in a comprehendible manner. Accordingly, real-world impact, especially related to the human experience, is able to be comprehended by/through machine intelligence to a degree never before seen.

The illustrated QPI automatically solicits and/or produces causally-linked natural-language real-world impact metrics from one or more entities, including a natural language text input system. This is generally accomplished over a network (e.g. website, intranet), over the bus of a user device, or the like or combinations thereof utilizing a user input device such as but not limited to a computer (e.g. desktop/laptop/pad) or phone (e.g. smartphone) using a GUI on a display with an input device like a keyboard or touchpad/touchscreen but could be done over some other device such as but not limited to being done over the phone audibly for the visually impaired or using other devices in situations and for purposes where typical devices are not optimal.

Generally, the QPI will utilize a user interface system such as but not limited to one generated using a programming language like HTML to allow for the display of the solicitation and to allow for input of desired metrics. The metrics will generally include some recitation of what happened in the real world, what is the believed cause of what happened, the perceived importance (e.g. this mattered to me, this mattered a lot to me, I really value this experience, this event is significant in my life, I really care that this happened, this significantly changed my life), and may include some indication of the desirability of the impact (e.g. I liked/desired/wanted it or I didn't like/etc. the result/event). Accordingly, the QPI solicits such metrics and then produces those metrics for use by the PG in a form that preserves the relationship between the event/result and the believed cause along with any other associated relevant information (e.g. desirability, importance, time, area). Generally, the QPI will utilize natural language expressions where possible instead of using numerical or other indexes. This allows for the resultant model to include such natural language as a part thereof, thereby increasing the quality and computer/AI comprehension of the model by the computerized system.

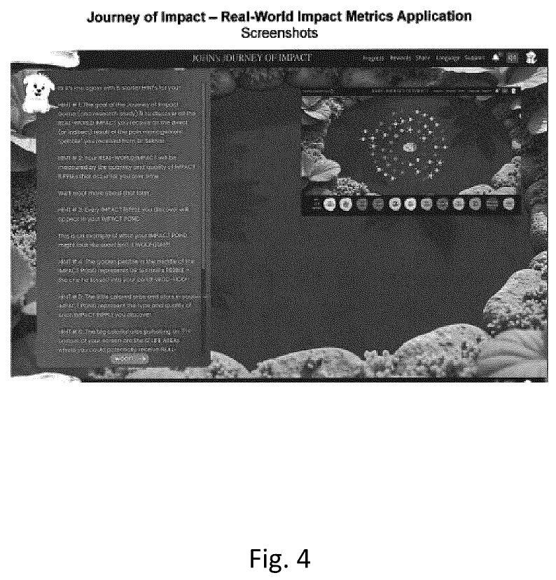

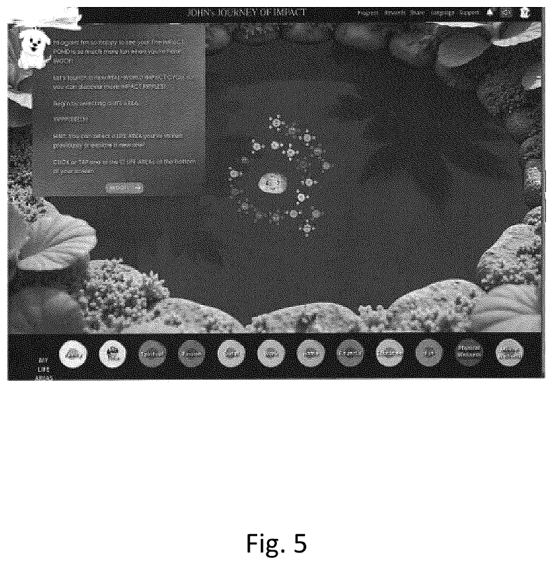

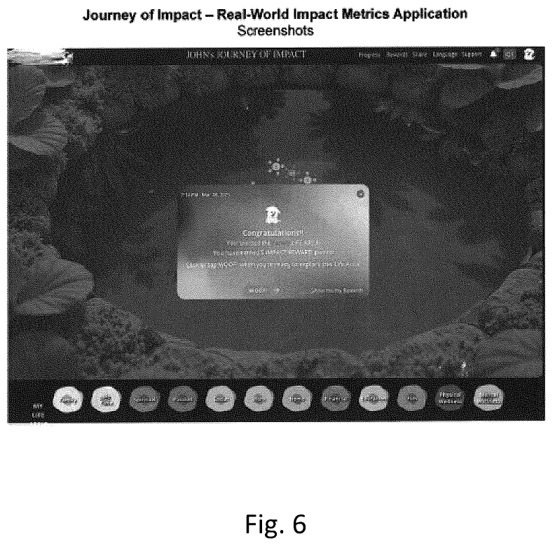

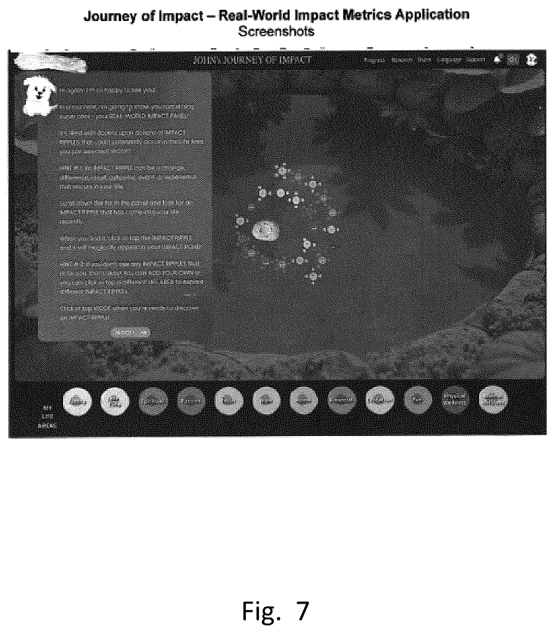

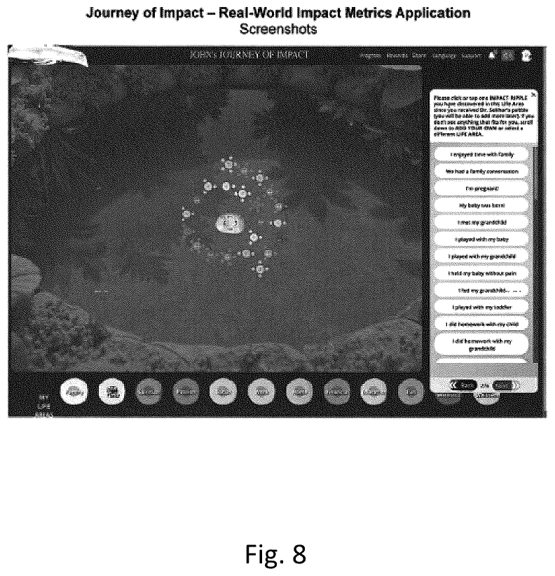

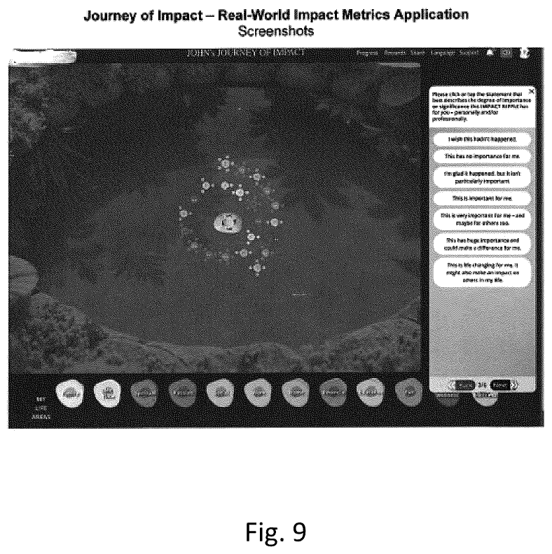

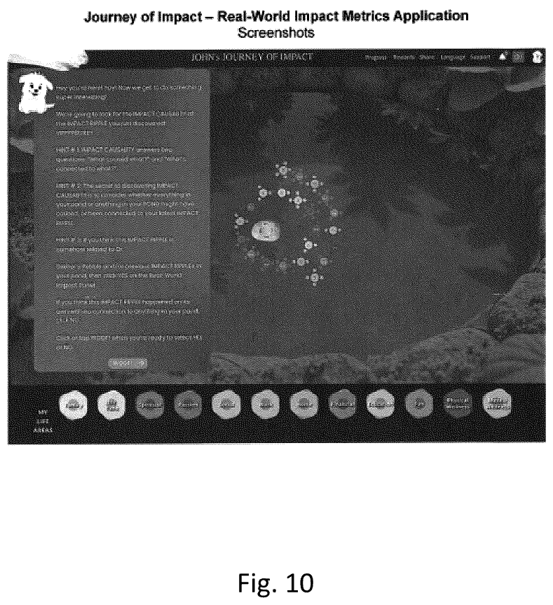

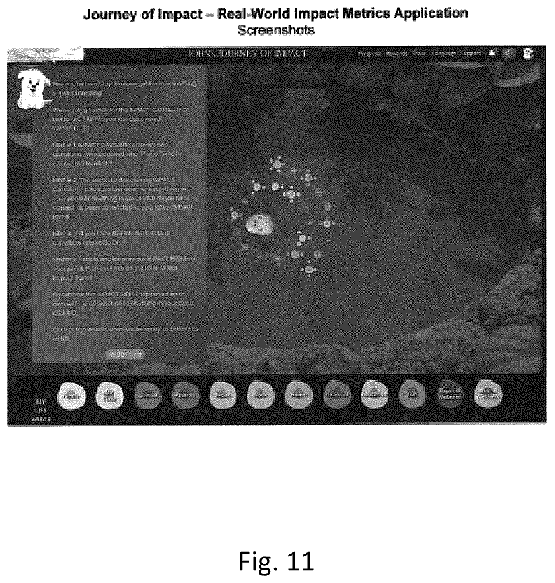

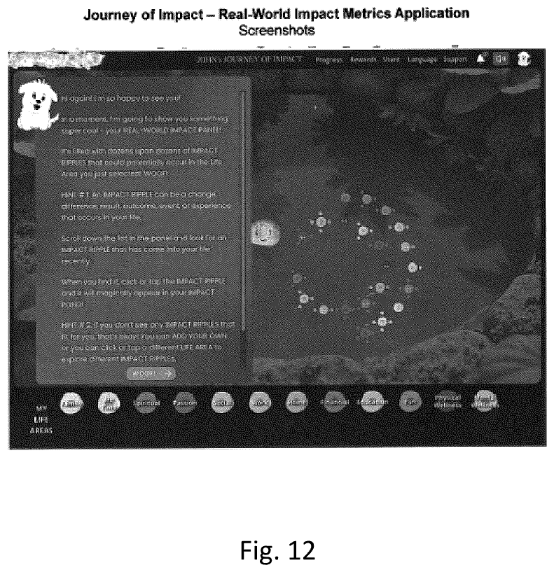

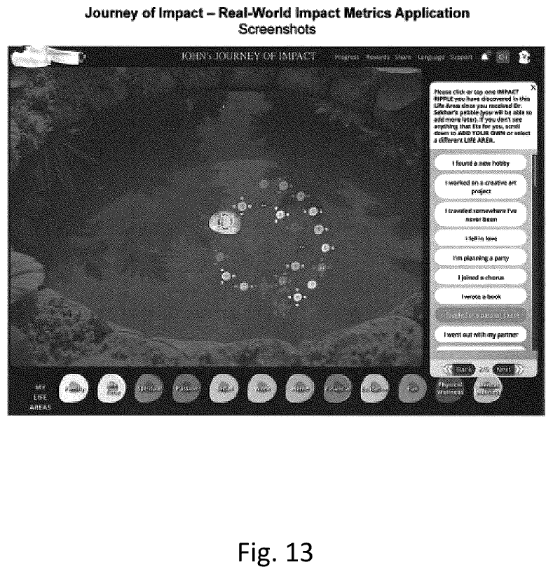

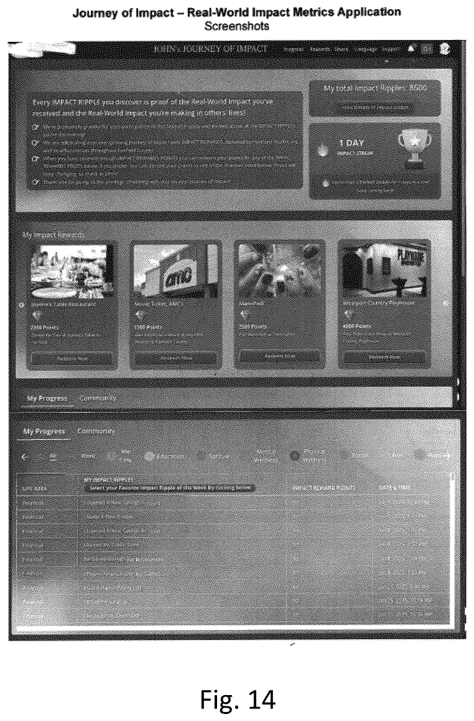

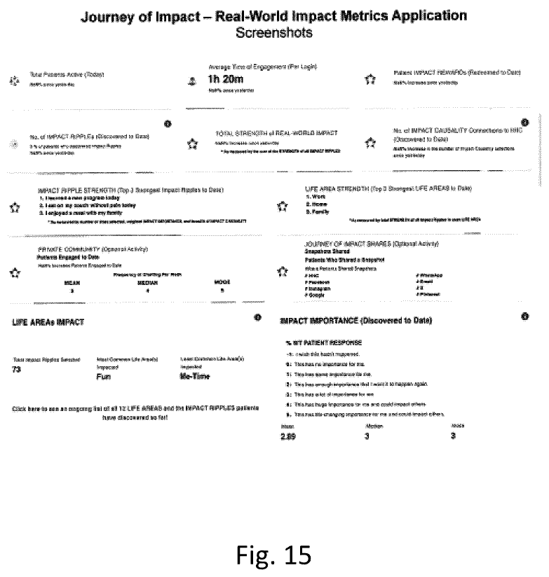

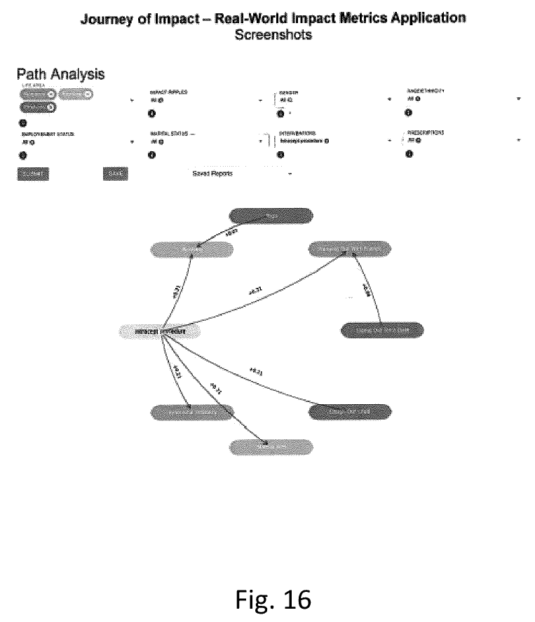

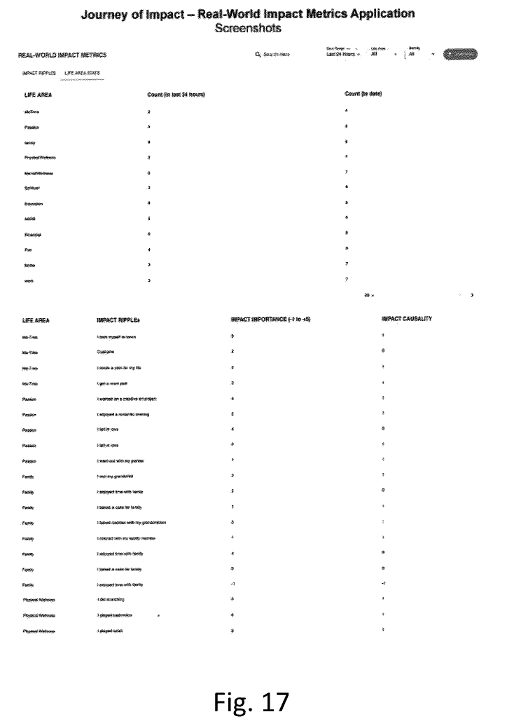

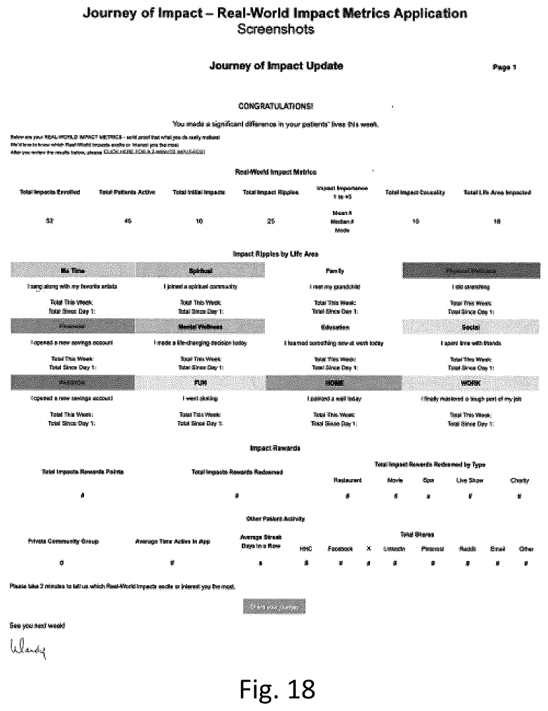

The natural language text input system allows for the entity entering impact metrics to input free-form natural language text instead of just selecting from choices. This allows for the input entity to describe in their own words the impact and/or associated metadata that will be provided for inclusion within the causal model. This will generally at least be implemented as a way to allow for input entities to provide impacts that are not on the list of impact events (sometimes herein referred to as ripples, wherein the root event is analogized as a pebble tossed into a pond, and thus the follow-on impact events/results are the ripples emanating from the intervention of the pebble, See also FIGS. 4-19). As a non-limiting example, if the list of impacts included: reduced pain, easier to move, slept better, and less irritable, and the input entity believed that their experience of “ran faster” was caused by, directly or indirectly, by one or more impact nodes already present, the input entity could type/say (e.g. text-to-speech)/input that phrase and it would be treated as though it was on the list by the system. Further, the free-form text input may also be implemented in other aspects of the input, including but not limited to importance index, area, and self/other designations. Advantageously, this allows for the input entities to provide much better impact information for the engine to digest and improves the overall quality of the resultant model.

The illustrated PG is functionally coupled to the query prompt interface and assembles causally-linked natural-language real-world impact metrics received therefrom into a machine-readable causal model. This is generally performed by receiving such information over a network and/or device bus from an QPI and then appending to an existing and/or root machine-readable causal model. While it is possible to generate such a model without a root event, it is generally more useful for causal analysis models to focus on a root event of particular interest. This root event is often something that the user of the system has done or has some other interest in evaluating the impact thereof.

As a non-limiting example, a root event may be an intervention of some sort, such as but not limited to a scientific experiment, a medical treatment, a psychological intervention, a product, a service, a change in a law or policy, and the like. The causal model then logically attaches in memory the received metrics as nodes connected, directly or indirectly, to the root event(s) so that those subsequent events can instruct in regard to the various impact “nodes” of the root event according to the experience/perception of those entering metrics into the system. This logical data structure will generally be formed as a tree-like structure with multiple nodes extending away from the root event. The nodes may be weighted and/or otherwise be metadata enriched to provide more useful comprehension in regard to the impact of the root event. Where there are multiple entities contributing metrics to the system (e.g. multiple patients that have received the same intervention/treatment, likely at different times), the model still generally only has a single root while metrics from each entity are attached to the same tree. At may be that disambiguation information (e.g. patient number/name) remains in the causal model where desired, but in instances where privacy/anonymity is desired, it may be not included, even if it is present in the data of the user device where the entity enters the information (since as they enter new “nodes” they have the option to attach causality to existing nodes that they previously entered).

The illustrated EG is in functional communication with the machine-readable causal model such that it can generate expressions derived therefrom. The EG may generate reports regarding statistical information within the causal model such as but not limited to (generally on a global/aggregate level, but could be at an entity level): total number of nodes, number of nodes with importance ranked above a threshold, number of entities contributing metrics, total number of nodes contributed, number of nodes per area of impact, most common impact areas, most common impacts, number of life areas impacted, mean impact interval (e.g. mean time for first impact node compared to known time of root event), total weight of impact, total weight of impact per area, mean/median/mode impact nodes per area per entity, unique impacts, total number of unique impacts, mean number of unique impacts per entity, and the like, and combinations thereof, including but not limited to various calculations of the strength of the impact.

It may be that the expression generator includes an expression script that generates natural-language expressions pulled from the causal model. Because the causal model includes nodes that consist primarily of natural language expressions, including but not limited to those input via the natural language text input system, the script can easily generate sentences and paragraphs from the causal model that are accurate representations of the model itself and therefore of the experienced impact by the input entities, but individually and collectively. Thus, the scripting could voluminous pages of textual information based on specific scripts and this could be continually produced as new data/nodes enter the system. Where time-stamps are included, the system could even produce time-variant pages of the same scripts so that there could be natural language statements produced in significant volume that evaluate the changes over time that the impact of the root event has had. This is particularly useful where some aspect of the root event is changed (e.g. the medical intervention is improved) and thus the change in impact can be described by these scripts.

As a non-limiting example, a script may look as follows (pseudo-programming, not specific to any particular language is used herein for readability): Print “The most common initial impact of the [Root event name/description] observed was [Most common initial metric input per input entity] which was most commonly experienced as [top ranked importance statement for the most common initial metric input per input entity].” While such a script could also be useful to produce and provide to a human user so they could better understand the causal model, it can be seen that the number and variation on such scripts are plethoric and it would be easy to generate scripts that produced far more information than would be digestible by a human user. However, this overabundance of production is actually very helpful for producing written material to feed into an existing LLM AI system. This would then easily allow for the LLM AI system to digest and comprehend the causal model and thereby get a useful comprehension regarding the real-world impact of the root event. Where the root event is an event selected by the AI system itself, this allows for the AI system to have accountability for its actions from the perspective of real-world entities, such as but not limited to human entities.

This capacity to produce causal models is culture and language agnostic, as the expressions themselves come from (directly with free-form text or indirectly by selection) the input entities. Further, the changes in impact over time, both individually and collectively, are captured and available within the model for utilization. As metrics are continually gathered, the model becomes simultaneously both a historic and real-time computer comprehension model of real-world impact. Where non-human entities, such as but not limited to animals capable of expressing preference (e.g. great apes, dolphins, ravens), are associated with the input entities, either as input entities if modes of input are developed for them to use, or indirectly via input from trainers/etc. then comprehension of impact on such creatures is also possible. This also means that machines able to express preference could be associated with/as input entities as well.

In one non-limiting embodiment of the invention, the natural-language causally-linked real-world impact metrics solicited by the query prompt interface includes at least one importance index and may include a desirability index. The desirability index will generally be expressed and recorded in natural language form (e.g. “I liked that this happened to me”). It may be that the desirability index includes at least one desirable desirability rating and at least one undesirable desirability rating (e.g. “I am happy to have experienced this” AND “I wish this had not happened to me”). It may be that the importance index includes at least one self-only importance rating and at least one self-and-others importance rating (e.g. “This made my life better” and “This helped both me and someone I care about”). Accordingly, the resulting causal model includes natural language expressions that detail the intensity of the impact. This increases comprehension of the impact of the root event.

In another non-limiting embodiment of the invention, the causally-linked natural-language real-world impact metrics solicited by the query prompt interface is metadata-enriched according to a natural language impact area (e.g. health, finances, relationships, goals, network speed, production output, strength improvement). This provides additional language for use with expression scripts and ways to characterize and/or solicit/inspire input from users to help make sure that a more full understanding of the impact is reached. It also helps with the comprehension of the final model where areas are lacking impact, especially of the user of the system was intentionally seeking to impact particular areas. As a non-limiting example, if an AI system was instructed to make an intervention intended to improve the financial situation of the input entities and there are no or only weak impact nodes in the “financial area” then that helps the AI system to recognize that it is not having the desired impact by its intervention. It may be that the natural language text input system includes schema extender that extends the set of natural language impact areas according to natural language input from an entity solicited thereby. Thus, if there are twelve “areas” that are in the system, it may be that the input entity could generate a thirteenth “area” that they can then use when they input ripples/nodes. That thirteenth area might only be expressly available from then on via their user interface or it may be propagated through the system, either automatically or after review by a user/administrator of the system.

In still yet another non-limiting embodiment of the invention the machine-readable causal model includes a common initiating node associated with a root event to which all assembled causally-linked natural-language real-world impact metrics are causally connected. This root event is generally going to be the focus of attention of the user/admin of the system which may be an intervention generated by the user or may be an outside event (e.g. getting an understanding of the real-world impact of a global pandemic). It may also be that they system could just allow users to input events on their own with no root event and each new event that is unconnected by causal relationship to a previous event becomes its own root event in the system. This could be useful in collecting data in a more free form sense, especially if a deep understanding of a particular input entity is desired. In this situation, each root event would then have its own causal model and there may be a larger model generated to associate or otherwise connect various causal models (e.g. by area) which may be useful for some purposes.

In still yet a further non-limiting embodiment of the invention, the machine-readable causal model is a directed acyclic graph (DAG) with weighted node importance for nodes associated with a single initiating node. Such a model would then utilize and/or enforce systemwide, and/or at the QPI and/or EG level the rules associated with DAG models such as but not limited to rules regarding forks, colliders, cycles, etc. Such may further take advantage of technologies that evaluate and/or analyze DAG models and such technologies may inform the scripts available/utilized in the system.

In still yet another further non-limiting embodiment of the invention, the system time-stamps causally-linked natural-language real-world impact metrics. This allows for time-based analysis and filtering, especially related to the root event, but also related to time spans between causally related nodes. The time stamps may be in real-time or may be expressed as relative time (e.g. root event is time=zero). It may be that the paradigm generator appends differential weighting metadata to an assembled causally-linked natural-language real-world impact metrics according to a time-stamp schema based on a time schedule centered on a time-stamp associated with a root event associated with an entity associated with the assembled causally-linked natural-language real-world impact metric. As a non-limiting example, there may be different weight given to impact events/ripples/nodes that occur within the first 48 hours after the root event. This may be of particular importance for interventions where early impacts are of increased/decreased importance.

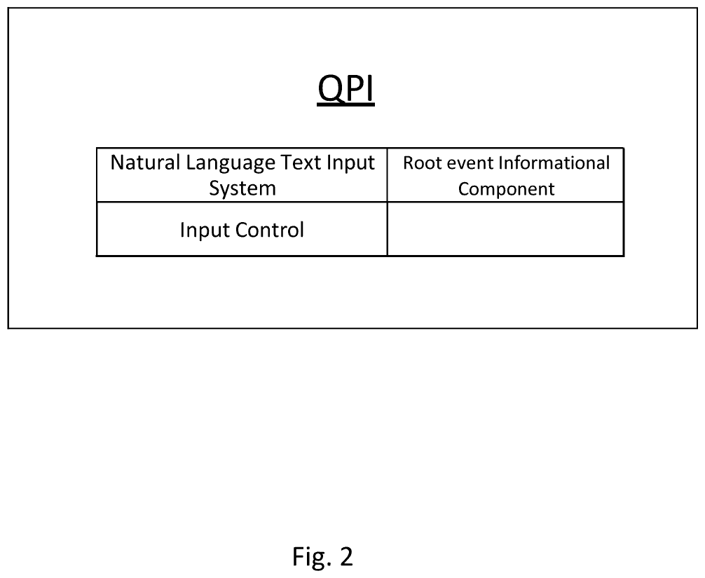

FIG. 2 is a block diagram of a query prompt interface, according to one embodiment of the invention. There is shown a natural language text input system, a root event informational component, and an input control. Advantageously, the query prompt interface is a special purpose computing tool to automatically solicit and produce machine-readable causally-linked natural-language real-world impact metrics, which are of particular importance for machine comprehension of real-world impacts of interventions and events. Such are historically very difficult for machines to comprehend.

The illustrated natural language text input system is generally a free-form text entry box but could instead by a selection that activates a text to speech input that allows the input entity to speak the desired input. Generally, such an input will include security controls/processes to make certain that the input is not interpreted as a command but instead is just utilized as natural language text.

The illustrated root event informational component displays a natural-language expression of a root event. This may be as simple as referring to the root event contextually (e.g. See FIGS. 4-19, “pebble” meaning the intervention by the doctor). It may include a natural language name/title/description of the root event. As long as it sufficiently identifies the root event to both the input entities and to the recipient of the output (e.g. expression generator), it is sufficient for the purposes of this invention.

The illustrated input control allows for input from the input entity to be received by the system in a machine-readable format. Generally, this will be a keyboard/touchscreen, but could include any other device capable of receiving natural language and selection input. The input control also requires that the user provide sufficient input to generate the desired metric. E.g. where there is only a single already existing root event, the metric cannot be submitted to the system without required information such as but not limited to a causal connection to the root event or a prior existing node. Other metadata enrichment described herein may also be required by the input control.

It may be that: the query prompt interface time stamps the real-world impact node selection input. Such a stamp may be automatic based on when the input entity inputs the node or may be manual where the input entity selects the time stamp to correspond to when the event occurred.

It may be that the selection input system further receives selection input of an importance index associated with a selected real-world impact node selection input. As a non-limiting example, there may be a list of selections that describe in natural language how intensely the impact experience of the selected node was for the input entity, whether the impact affected others or just themselves, and whether the impact was positive or negative. The input control may also include selections that allow for the input entity to append natural language additions to lists of selections such as but not limited to areas, impact events, importance index, and the like. It may also allow for multiple causation relationships to be associated with a single node, e.g. the selected impact event was caused by more than one previous impact node.

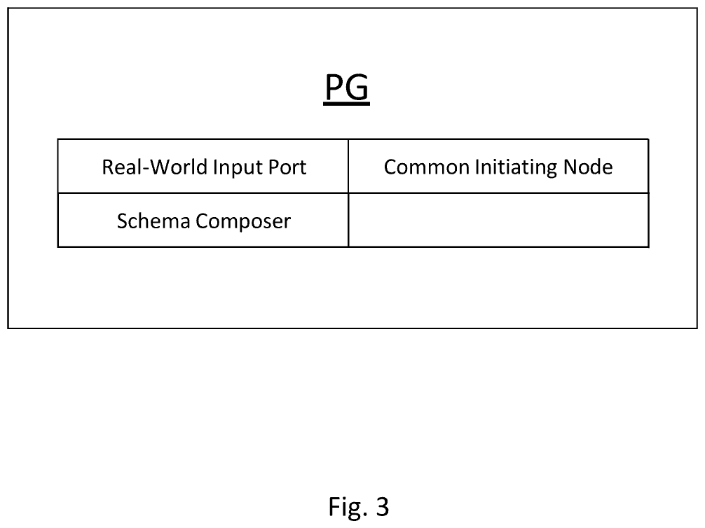

FIG. 3 is a block diagram of a special purpose paradigm engine, according to one embodiment of the invention. There is shown a real-world input port, a common initiating node, and a schema composer. Advantageously, the paradigm engine is able to take incoming impact metrics and to produce a useful paradigm (machine-readable real-world causal model) that allows for machine comprehension of real-world impact associated with a root event.

The illustrated real-world input port is configured to receive causally-linked natural-language real-world impact metrics that may be associated with a root event. This is generally accomplished via a computer port functionally coupled to a processor, e.g. of a server and also functionally coupled to a QPI.

The illustrated common initiating node is associated with a specific root event. This special node may include rules and/or description not included with other nodes in the model, such as but not limited to being write-only and not having a connection to another other node via a causality source. The common initiating node forms the root of the model from which all other nodes extend.

The illustrated schema composer functionally couples received causally-linked natural-language real-world impact metrics to the common initiating node as impact nodes/ripples in accordance with causality information included with the received causally-linked natural-language real-world impact metrics thereby appending an impact node to a schema including the common initiating node. This may be accomplished via one or more data structures that establish links between records or via more complex programming tools, such as generating related objects or other similar structures.

It may be that the impact nodes are metadata enriched with weighting, time information relative to time information of the root event. It may be that the weighting includes time differential weighting (e.g. weighting that changes based on time relationships between nodes, which could be greater weighting for earlier nodes). It may be that the weighting includes importance weighting associated with one or more importance index responses (e.g. where a natural language importance response is also assigned a numerical weighting value). It may be that the weighting includes both desirability and undesirability weighting. It may be that the impact nodes are metadata enriched with self or self-plus-other ratings. It may be that the impact nodes are metadata enriched with natural-language impact area.

FIGS. 4-18 are prophetic screenshots of a web-based user interface of a query prompt interface showing deployment thereof from the point of view of a human entity providing real-world impact metrics, according to one embodiment of the invention. The prophetic screenshots show explanation given to an input entity on what they are inputting and how to recognize what is a valid input from their perspective and experience. They also show twelve areas (“life areas”) corresponding to different types of impact ripples/nodes. There is shown a pond with impact ripples already input into the system being displayed for the input entity and explains that additional impact ripples will appear in the pool as they are provided.

The screenshots give non-limiting exemplary lists of selectable natural language impacts according to one embodiment of the invention and also show selectable natural language importance indexes. An explanation of causality is provided to assist the input entity in properly associating causality for the ripples. An overview page is shown that illustrates a plurality of impact ripples already provided by the input entity on the associated account along with engagement motivation tools to help the input user stayed engaged with the system.

There is also shown a plurality of output reports produced from the comprehension model and a graphic illustrating a comprehension model showing a root event with associated impact nodes.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A machine comprehension system, configured to generate machine-comprehendible real-world impact paradigms, comprising:
a. a query prompt interface that automatically solicits and produces causally-linked natural-language real-world impact metrics from one or more entities, including a natural language text input system; and
b. a paradigm generator functionally coupled to the query prompt interface, wherein the paradigm generator assembles causally-linked natural-language real-world impact metrics received therefrom into a machine-readable causal model.

2. The machine comprehension system of claim 1, further comprising an expression generator in functional communication with the machine-readable causal model such that it can generate expressions derived therefrom.

3. The machine comprehension system of claim 2, wherein the expression generator includes an expression script that generates natural-language expressions.

4. The machine comprehension system of claim 1, wherein the natural-language causally-linked real-world impact metrics solicited by the query prompt interface includes at least one importance index.

5. The machine comprehension system of claim 1, wherein the natural-language causally-linked real-world impact metrics solicited by the query prompt interface includes at least one importance index including at least one desirable desirability rating and at least one undesirable desirability rating.

6. The machine comprehension system of claim 4, wherein the importance index includes at least one self-only importance rating and at least one self-and-others importance rating.

7. The machine comprehension system of claim 1, wherein the causally-linked natural-language real-world impact metrics solicited by the query prompt interface is metadata-enriched according to a natural language impact area.

8. The machine comprehension system of claim 7, wherein the natural language text input system includes schema extender that extends the set of natural language impact areas according to natural language input from an entity solicited thereby.

9. The machine comprehension system of claim 1, wherein the machine-readable causal model includes a common initiating node associated with a root event to which all assembled causally-linked natural-language real-world impact metrics are causally connected.

10. The machine comprehension system of claim 1, wherein the wherein the machine-readable causal model is a directed acyclic graph (DAG) with weighted node importance for nodes associated with a single initiating node.

11. The machine comprehension system of claim 1, wherein the system time-stamps causally-linked natural-language real-world impact metrics.

12. The machine comprehension system of claim 11, wherein the paradigm generator appends differential weighting metadata to an assembled causally-linked natural-language real-world impact metrics according to a time-stamp schema based on a time schedule centered on a time-stamp associated with a root event associated with an entity associated with the assembled causally-linked natural-language real-world impact metric.

13. A special-purpose paradigm generator that generates a machine-readable real-world causal model, comprising:
a. a real-world input port configured to receive causally-linked natural-language real-world impact metrics associated with a root event;
b. a common initiating node associated with the root event; and
c. a schema composer that functionally couples received causally-linked natural-language real-world impact metrics to the common initiating node in accordance with causality information included with the received causally-linked natural-language real-world impact metrics thereby appending an impact node to a schema including the common initiating node.

14. The special-purpose paradigm generator of claim 13, wherein the impact nodes are metadata enriched with weighting.

15. The special-purpose paradigm generator of claim 14, wherein the impact nodes are metadata enriched with time information relative to time information of the root event.

16. The special-purpose paradigm generator of claim 14, wherein the weighting includes time differential weighting.

17. The special-purpose paradigm generator of claim 14, wherein the weighting includes importance weighting.

18. The special-purpose paradigm generator of claim 14, wherein the weighting includes both desirability and undesirability weighting.

19. The special-purpose paradigm generator of claim 13, wherein the impact nodes are metadata enriched with self or self-plus-other ratings.

20. The special-purpose paradigm generator of claim 13, wherein the impact nodes are metadata enriched with natural-language impact area.

21. A special-purpose query prompt interface that automatically generates machine-readable causally-linked natural-language real-world impact metrics, comprising:
a. a root event informational component that displays a natural-language expression of a root event; and
b. an input control including:
i. a selection input system for receiving real-world impact node selection input and causality selection input from an entity;
ii. a natural language text input system for receiving natural-language input from an entity and thereby generating real-world impact nodes therefrom not already available for selection via the selection input system;
iii. a metric generator that generates causally-linked natural-language real-world impact metrics based on received impact node and causality selection by the entity by linking received real-world impact node selection input and causality selection input to the root event in a machine-readable form.

22. The query prompt interface of claim 21, wherein the query prompt interface time stamps the real-world impact node selection input.

23. The query prompt interface of claim 21, wherein the selection input system further receives selection input of an importance index associated with a selected real-world impact node selection input.

24. The query prompt interface of claim 23, wherein selection input system further receives selection input of a desirability index that includes at least one desirable desirability rating and at least one undesirable desirability rating.

25. The query prompt interface of claim 23, wherein the importance index includes at least one self-only importance rating and at least one self-and-others importance rating.

26. The query prompt interface of claim 21, wherein the selection input system further receives selection input of an area associated with a selected real-world impact node selection input.

27. The query prompt interface of claim 21, wherein the natural language text input system includes schema extender that extends the set of natural language impact areas according to natural language input from an entity solicited thereby.
